(19) United States
(12) Patent Application Publication
(10) Pub. No.: US 2006/0103620 A1
(43) Pub. Date: May 18, 2006

(54) Driver chip for a display device and display device having the same

(75) Inventors: Soong-Yong Joo, Seongnam-si (KR); Il-Gon Kim, Seoul (KR); Kook-Chul Moon, Yongin-si (KR); Ho-Suk Maeng, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/270,981

(22) Filed: Nov. 12, 2005

(30) Foreign Application Priority Data
Nov. 16, 2004 (KR) 2004-93637

(51) Int. Cl. G09G 3/36

(52) U.S. Cl. 345/98

(57) ABSTRACT

A display device includes a PCB, a driver chip and a display panel. The driver chip is mounted on an FPCB that is electrically coupled to the PCB and to the display panel. The driver chip includes a first circuit operating at a relatively low voltage and a relatively high frequency. The display panel includes an array of pixels and a second circuit for driving the pixels. The second circuit operates at a relatively high voltage and a relatively low frequency. Therefore, the manufacturing efficiency of a driver chip IC may be increased.

### CROSS REFERENCE TO RELATED APPLICATION

This application claims priority under 35 USC § 119 of Korean Patent Application No. 2004-93637, filed on Nov. 16, 2004, the contents of which are herein incorporated by reference in its entirety for all purposes.

### BACKGROUND OF THE INVENTION

1. Field of the Invention

The present invention relates to a driver chip for a LCD display device and, more particularly to a driver chip assembly for a display device capable of increasing manufacturing efficiency of a driver chip IC.

2. Description of the Related Art

Display devices are employed in a variety of electronic apparatuses, for example, such as cell phones, PDAs, portable multimedia devices, desktop computers, laptop computers, etc.

Types of display devices include a cathode ray tube (CRT), a plasma display panel (PDP), an organic light emitting display (OLED), a liquid crystal display (LCD), etc. The LCD device has various useful characteristics, for example, such as lighter weight, smaller size, higher resolution, lower power consumption and more eco-friendly than the CRT.

In the typical LCD device, the arrangement of liquid crystal molecules is varied in response to an electric field applied thereto, and thus optical characteristics (including birefringence, luminance, diffusion, etc.) of a layer of a pixel comprising the liquid crystal molecules is changed.

The LCD device classified as either a twisted nematic (TN) LCD device (using a TN liquid crystal) or a super-twisted nematic (STN) LCD device (using a STN liquid crystal) due to types of the liquid crystal arrangements. The LCD device is also classified as either an active matrix LCD device (having a switch in each pixel) or a passive matrix LCD device, based on circuits for driving the liquid crystal. The active matrix LCD device is typically a TN LCD device, and the passive matrix LCD device is typically a STN LCD device.

The active matrix LCD device is different from the passive matrix LCD device in that the active matrix LCD uses a thin film transistor (TFT) as the switch in each pixel. Since the passive matrix LCD device does not use a switch (e.g., TFT) in each pixel, the passive matrix LCD device does less design complexity.

A TFT may be classified as an amorphous silicon TFT (a-Si TFT, e.g., used in FIG. 1) or a poly-silicon TFT (Poly-Si TFT, e.g., used in FIG. 2). The poly-Si semiconductor film substrate has a carrier (electron) mobility greater than or equal to about 30 cm²/Vsec while the amorphous-silicon semiconductor film substrate has a carrier (electron) mobility of about 0.5 cm²/Vsec. Thus, an LCD device employing poly-Si TFTs may be driven by a signal having a higher frequency (e.g., by about several megahertz (MHz)).

In addition, poly-Si TFT may be classified into a high temperature poly-silicon (HTPS) TFT and a low temperature poly-silicon (LTPS) TFT based on processing temperature. A HTPS TFT is formed on a poly-silicon (crystal) substrate at a temperature above about 1000° C. and a LTPS TFT is formed on a glass substrate at a temperature below about 650° C.

Thus, despite lower power consumption and lower cost compared with the a-Si TFT LCD device, the poly-Si TFT LCD device has disadvantages including that the poly-Si TFT LCD device requires more complex manufacturing process than the a-Si TFT LCD device. As a result, the poly-Si TFT LCD device is more frequently used to implement small-screen display devices such as in IMT-2000 cellular phones (third generation mobile communications systems).

A a-Si TFT LCD device has higher manufacturing yield than a poly-Si TFT LCD device and has a larger screen so that a-Si TFT LCD devices are mainly applied to large-screen display devices, such as for example in a notebook personal computer, in an LCD monitor, in a high definition television (HDTV) receiver set, etc.

FIG. 1 is a schematic view illustrating a conventional poly-Si TFT liquid crystal display device including a poly-Si thin film transistor (TFT) substrate.

Referring to FIG. 1, the ploy-Si TFT LCD device includes a glass substrate 10 on which a data drive circuit 12 and a gate drive circuit 14 are formed. The data drive circuit 12 and the gate drive circuit 14 are electrically coupled to a terminal 16. The terminal is electrically coupled to an integrated printed circuit board (PCB) 20 via a film cable 18. The ploy-Si TFT LCD device allows for lower manufacturing cost and reduced power consumption by using the integrated driver circuits.

FIG. 2 is a schematic view illustrating a conventional a-Si TFT liquid crystal display device including a-Si thin film transistor (TFT) substrate.

In FIG. 2, the a-Si TFT LCD device includes a plurality of data driver chips 34 formed on a plurality of flexible printed circuit boards (FPCB) 32 in a chip on film (COF) manner. A data PCB 36 is coupled to a plurality of source line terminals of a pixel array on a glass substrate 10 via the plurality of FPCBs 32. Further, a plurality of gate driver chips 40 are formed on the plurality of FPCBs 38 in the COF manner and are connected to the gate PCB 42. Alternatively, the integrated data PCB (in which a power supply of the gate driver is mounted) may also be used to implement the gate PCB 42. Specifically, a source driver, DC-to-DC converter, a gate driver, etc., may be integrated on a single chip IC for easier manufacturing of a display module.

However, when using the integrated PCB, a frame memory of a liquid crystal display device employed in a mobile phone also needs to be integrated on the single chip IC because a CPU interface (or system interface) is widely used for the liquid crystal display device employed in a mobile phone. For example, components for a high speed serial interface (for reducing the number of connection pins of an interface of the liquid crystal display device) and components for performing multimedia functions (such as an MPEG-4, 3-D implementation) also need to be integrated on the single chip IC.

However, since the process of manufacturing the DC-to-DC converter and the gate driver IC differs from the process of manufacturing a memory and a digital circuit for multimedia function, the manufacturing efficiency, in terms of size and cost, of the integrated circuit (IC) is reduced.

The mobile display digital interface (MDDI) standard, a high-speed serial interconnection technology developed by QUALCOMM, increases reliability and reduces power consumption in clamshell and slide mobile phones by greatly decreasing the number of wires through the hinge.

### SUMMARY OF THE INVENTION

An aspect of the present invention provides a display device, that incorporates the following features: a timing controller, a source driver, a gate driver, a power supply (DC-to-DC converter), and a frame buffer memory (SRAM), in addition to the built-in MDDI display interface.

An aspect of the present invention provides a driver chip IC wherein a circuitry that operates at a relatively low voltage and a relatively high frequency is integrated (e.g., on the liquid crystal display panel) at the same time that a circuitry that operates at a relatively high voltage and a relatively low frequency is integrated, to maximize the manufacturing efficiency.

Another aspect of the present invention also provides a display device including the above driver chip ICs.

Exemplary embodiments of the present invention provide a driver chip IC for a display device that is mounted on a flexible printed circuit board (FPCB) electrically coupled between a printed circuit board (PCB) and a display panel. The driver chip IC includes a serial interface, a timing generator and a memory. The serial interface converts a first image data provided from a baseband IC on the PCB to a second image data and outputs the second image data. The timing generator outputs a second control signal based on a first control signal provided from the PCB. The memory stores the second image data and outputs the stored second image data to the display panel based on the second control signal.

Exemplary embodiments of the present invention also provide a display device that includes a PCB (e.g., carrying a baseband IC), a driver chip IC and a display panel. The driver chip IC includes a first circuit operating at a relatively low voltage and at a relatively high frequency, mounted on an FPCB electrically coupled to the PCB. The display panel includes a plurality of pixels and a second circuit for driving the pixels, wherein the second circuit operates at a relatively high voltage and a relatively low frequency.

As described above, circuitry such as the source driver, the gate driver and the DC-to-DC converter operating at a relatively high voltage and a relatively low frequency are integrated in the liquid crystal display panel, and a dedicated IC including circuitry that operates at a relatively low voltage and a relatively high frequency is separately mounted coupled to the liquid crystal display panel. Thus, the manufacturing efficiency may be maximized.

### BRIEF DESCRIPTION OF THE DRAWINGS

The above and other features of the present invention will become readily apparent by reference to the following detailed description when considered in conjunction with the accompanying drawings wherein:

FIG. 1 is a schematic view of a conventional liquid crystal display (LCD) device including thin film transistors (TFT) formed in a poly-Si substrate;

FIG. 2 is a schematic view of a conventional liquid crystal display (LCD) device including thin film transistors (TFT) formed in an a-Si substrate;

FIG. 3 is a block diagram of a liquid crystal display (LCD) device according to an exemplary embodiment of the present invention;

FIG. 4 is a circuit block diagram of the liquid crystal display device of FIG. 3;

FIGS. 5A and 5B together are a detailed circuit block diagram of the liquid crystal display device of FIG. 3;

FIG. 6 is a block diagram illustrating the graphic controller IC 120 shown in FIG. 5A;

FIGS. 7A and 7B are circuit diagrams illustrating the interconnected first serial interface 130 and second serial interface 210 shown in FIG. 5A;

FIG. 7C is a timing diagram illustrating the timing of signals in the first serial interface 130 and second serial interface shown in FIGS. 7A and 7B;

FIG. 8 is a detailed block diagram illustrating the pixel driving circuits of the liquid crystal display (LCD) device in FIGS. 5A and 5B;

FIG. 9 is a detailed block diagram illustrating the level shifter 330 shown in FIGS. 5B and 8;

FIG. 10 is a timing diagram illustrating waveforms of input and output signals of the level shifter 330 of FIG. 9;

FIG. 11 is a circuit diagram illustrating the gate driver 400 shown in FIGS. 4 and 8;

FIG. 12 is a detailed circuit diagram illustrating a poly-Si tri-state (gated) inverter used in FIG. 11;

FIG. 13 is a detailed circuit diagram illustrating the source (data) driver 320 shown in FIGS. 5B and 8;

FIG. 14 is a circuit block diagram illustrating an apparatus for driving a liquid crystal display (LCD) device according to another exemplary embodiment of the present invention;

FIG. 15 is a block diagram illustrating a gate driver 900 for use with the circuit of FIG. 14; and

FIG. 16 is a detailed block diagram illustrating the source driver 820 shown in FIG. 14.

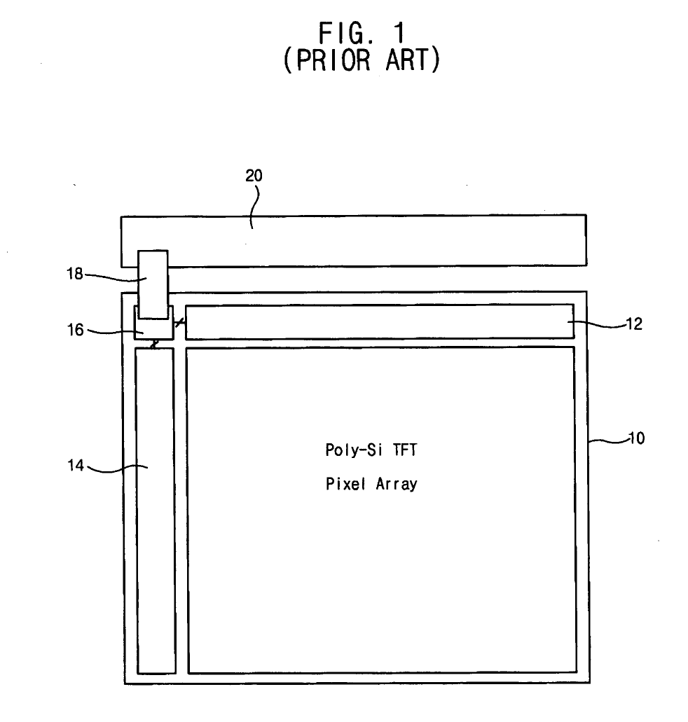

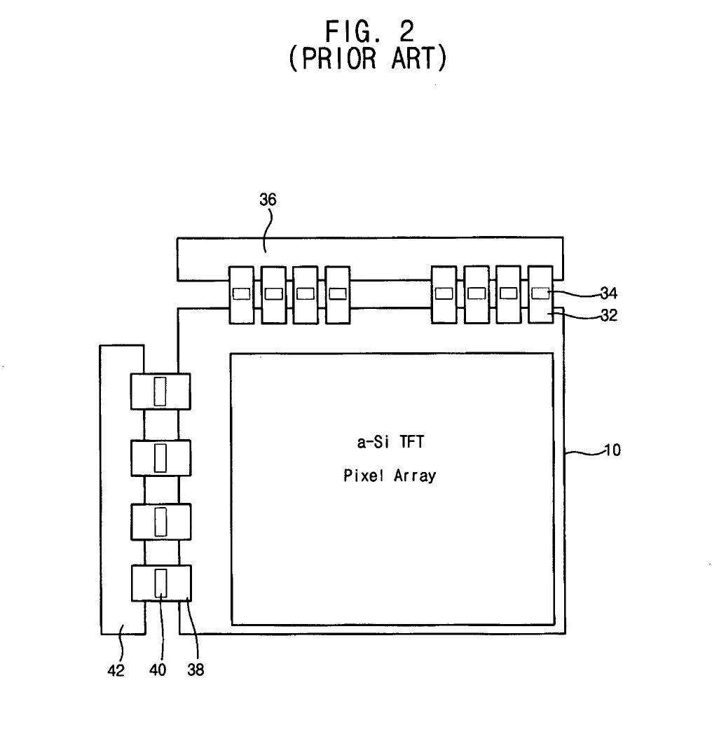

### DETAILED DESCRIPTION OF EXEMPLARY EMBODIMENTS OF THE INVENTION

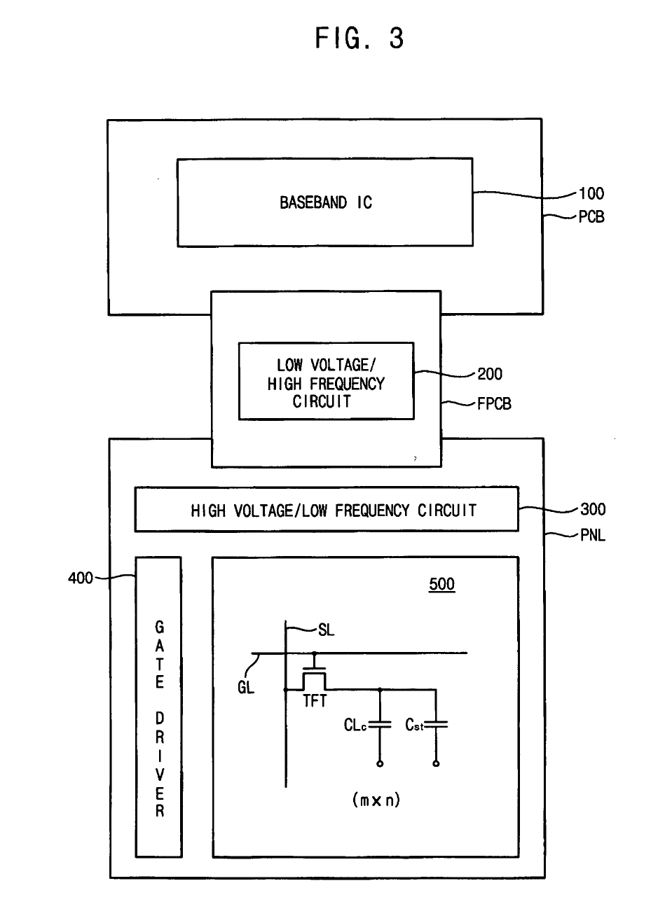

FIG. 3 is a block diagram illustrating an active matrix liquid crystal display (LCD) device according to an exemplary embodiment of the present invention.

Referring to FIG. 3, the liquid crystal display device includes a printed circuit board (PCB), a flexible printed circuit board (FPCB) and a display panel PNL.

The PCB includes a baseband IC 100 and is physically and electrically coupled to the FPCB.

A low voltage/high frequency circuit 200 operating at a relatively low voltage and a relatively high frequency is formed on the FPCB coupling the PCB to the display panel PNL. The low voltage/high frequency circuit 200 has an operating voltage lower than the operating voltage of a level shifter formed in a peripheral area of the display panel PNL and an operating frequency higher than the operating frequency of the level shifter.

The display panel PNL includes a display area (including m×n pixel array 500) and the peripheral area to display an image based on a control signal and an image signal that are provided from the FPCB to which the display panel PNL is electrically coupled. A high voltage/low frequency circuit 300 (operating at a relatively high voltage and a relatively low frequency) is formed in the peripheral area. A gate driver 400 for sequentially outputting a gate signal is also formed in the peripheral area. A pixel array 500 having a plurality (m×n) of pixels is formed in the display area.

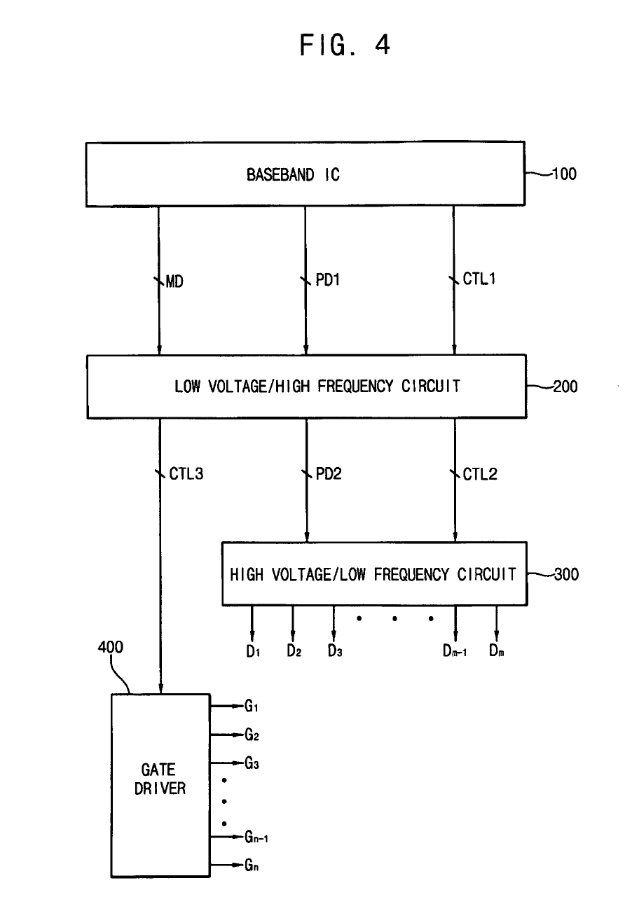

Each of the m×n pixels is formed in an area defined by the intersection of intersecting gate lines GL (e.g., G₁, G₂, G₃, Gₙ₋₁, Gₙ shown in FIG. 4) and source lines SL (e.g., D₁, D₂, D₃, Dₘ₋₁, Dₘ shown in FIG. 4). Each pixel has a transistor channel layer comprising polysilicon. Thus, each pixel includes a switch comprised of a poly-Si TFT having gate and source electrodes electrically coupled to the gate lines GL and the source line SL, respectively.

The gate line GL (e.g., D₁, D₂, D₃, Dₘ₋₁, Dₘ shown in FIG. 4) provides a gate signal to the gate of the poly-Si TFT and the source line SL provides a data signal to the source electrode of the poly-Si TFT. The poly-Si TFT has a drain electrode commonly coupled to a liquid crystal capacitor Clc and a to storage capacitor Cst (as shown in FIG. 3).

As described above, in a liquid crystal display (LCD) device having the poly-Si TFT, the circuit operating at a relatively high voltage and a relatively low frequency is integrated on a liquid crystal display panel (PNL), and the circuit 200 operating at a relatively low voltage and a relatively high frequency is integrated in a separate dedicated IC. Therefore, a manufacturing efficiency of a driver chip IC may be increased.

FIG. 4 is a circuit block diagram of the liquid crystal display device of FIG. 3.

Referring to FIG. 4, the drive apparatus of the liquid crystal display device includes a baseband IC 100, a low voltage/high frequency circuit 200, a high voltage/low frequency circuit 300, and a gate driver 400.

The baseband IC 100 provides the low voltage/high frequency circuit 200 with a first image data PD1, a first control signal CPL1 corresponding to the first image data PD1 and an MPEG-4 data MD.

The low voltage/high frequency circuit 200 provides the high voltage/low frequency circuit 300 with a second image data PD2 and a second control signal CTL2 and provides the gate driver 400 with a third control signal CPL3 corresponding to the second image data PD2 based on the first image data PD1, the first control signal CPL1 and the MPEG-4 data MD.

The high voltage/low frequency circuit 300 provides a plurality of data voltages D1, D2, . . . , Dm-1, Dm to the pixel array 500 based on the second image data PD2 and the second control signal CTL2.

The gate driver 400 sequentially provides the pixel array 500 with a plurality of gate signals G1, G2, . . . , Gn-1, Gn based on the third control signal CTL3.

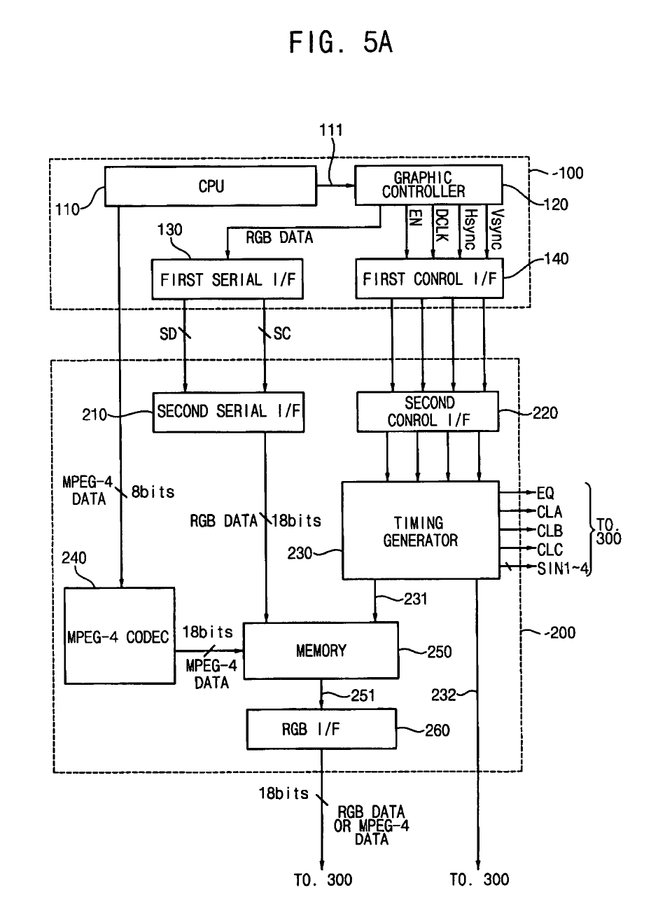

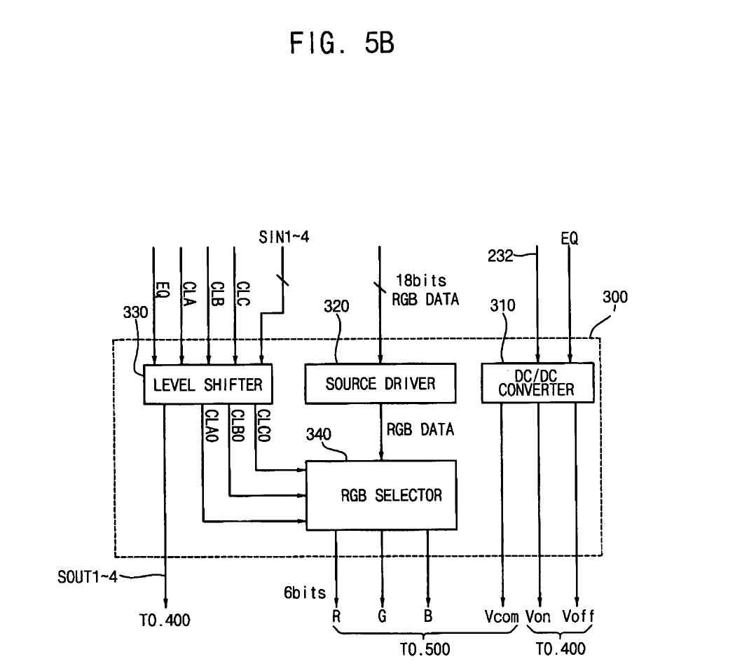

FIGS. 5A and 5B are together a detailed block diagram of the liquid crystal display (LCD) device of FIG. 3.

Referring to FIGS. 5A and 5B, the drive apparatus of the liquid crystal display device includes a baseband IC 100, a low voltage/high frequency circuit 200 formed in the printed circuit board (PCB) and a high voltage/low frequency circuit 300 formed in the display panel PNL.

The baseband IC 100 includes a central processing unit (CPU), a graphic controller IC 120, a first serial interface 130 and a first control interface 140. The CPU 110 provides a source image data 111 to the graphic controller IC 120 and provides the MPEG-4 data to the low voltage/high frequency circuit 200.

The graphic controller IC 120 provides a digital pixel data (RGB data) to the first serial interface 130 and clock signals such as Vsync, Hsync, DCLK, EN, etc., to the first control interface 140.

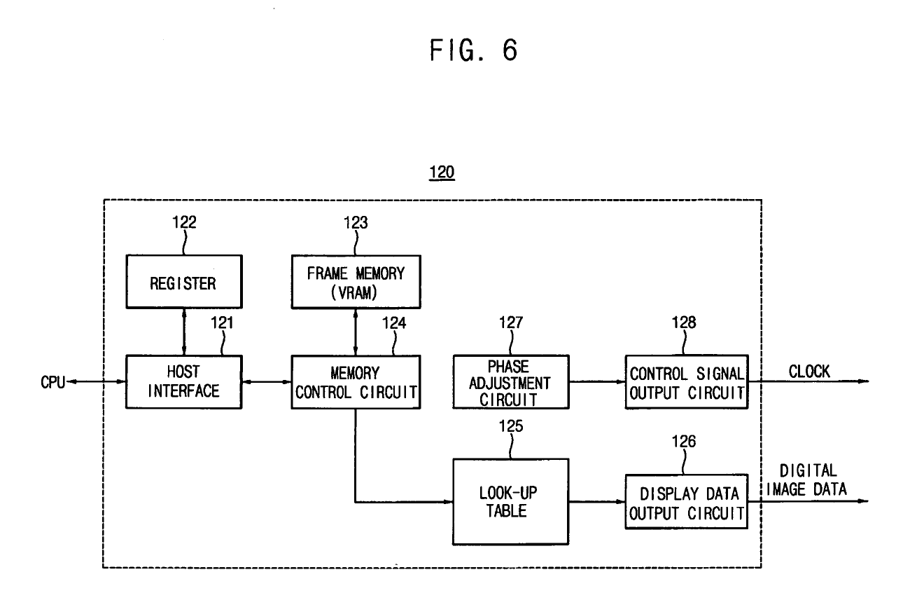

FIG. 6 is a block diagram illustrating the graphic controller IC 120 shown in FIG. 5A. As shown in FIG. 6, the graphic controller IC 120 includes a host interface 121 (for interfacing with the CPU 110 shown in FIG. 5A), a register 122, a (video) frame memory (VRAM) 123, a memory control circuit 124, a look-up table 125, a display data output circuit 126, a phase adjustment circuit 127 and a control signal output circuit 128. The graphic controller IC 120 converts the source image data 111 (provided from the CPU 110 shown in FIG. 5A) to a CLOCK signal and a DIGITAL IMAGE DATA. The converted clock signal is provided to the first control interface 140 (shown in FIG. 5A) and the converted digital image data is provided to the first serial interface 130 (shown in FIG. 5A).

The first serial interface 130 (FIG. 5A) provides a serial data SD and a serial clock SC (based on the digital image data (RGB data) from the graphic controller IC 120) to the low voltage/high frequency circuit 200. The serial data SD may include a MDDI (mobile display digital interface, a high-speed serial interface) data having a positive polarity and MDDI data having a negative polarity. The serial clock SC includes an MDDI strobe signal having a positive polarity and the MDDI strobe signal having a negative polarity. The MDDI strobe signals are transmitted to the low voltage/high frequency circuit 200 via a pair of interconnection lines (SC) and the MDDI data are transmitted via a number (for example, 1, 2, 4, 8) of the interconnection lines (SD).

The first control interface 140 provides the low voltage/high frequency circuit 200 with the clock signals such as Vsync, Hsync, DCLK, EN, etc., that are received from the graphic controller IC 120. Vsync is a vertical synchronization signal, Hsync is a horizontal synchronization signal, DCLK is a dot clock and EN is a data enable signal.

Referring to FIG. 5A, the low voltage/high frequency circuit 200 includes a second serial interface 210, a second control interface 220, a timing generator 230, an MPEG-4 CODEC 240, a memory 250 and a first RGB interface 260. The second serial interface 210 receives the serial data SD and the serial clock SC from the first serial interface 130 and deserializes the serial data SD to provide the memory 250 with a parallel (e.g. 18-bit wide) image data.

The second control interface 220 receives the clock signals Vsync, Hsync, DCLK, EN, etc., via the first control interface 140 and provides the clock signals Vsync, Hsync, DCLK, EN, etc., to the timing generator 230.

The timing generator 230 generates a plurality of control signals 231, 232, EQ, CLA, CLB, CLC and SIN1 through SIN4 based on the clock signals Vsync, Hsync, DCLK, EN received from the second control interface 220. The control signals 231, 232, EQ, CLA, CLB, CLC and SIN1 through SIN4 are provided to the high voltage/low frequency circuit 300 (See FIG. 5B).

The MPEG-4 CODEC 240 receives the coded MPEG-4 data from the CPU 110 and decodes the MPEG-4 data to provide decoded MPEG-4 data to the memory 250. The coded MPEG-4 data has eight bits and the decoded MPEG-4 data has eighteen bits.

The memory 250 stores 18-bit image data (provided from the second serial interface 210) and stores 18-bit decoded MPEG-4 data (provided from the MPEG-4 CODEC 240) based on the control signal 231 provided from the timing generator 230. The memory 250 stores the image data or the MPEG-4 data corresponding to one frame.

The memory 250 supplies the first RGB interface 260 with one of the stored 18-bit image data and the stored 18-bit MPEG-4 data (selected by the control signal 231 provided from the timing generator 230).

The first RGB interface 260 provides the high voltage/low frequency circuit 300 (FIG. 5B) with the selected one of the 18-bit image data and the 18-bit MPEG-4 data provided from the memory 250.

Referring to FIG. 5B, the high voltage/low frequency circuit 300 includes a DC-to-DC converter 310, a (TFT) source driver 320, a level shifter 330 and an RGB selector 340. The DC-to-DC converter 310 supplies the gate driver 400 (see FIGS. 3, 4 and 11) with gate tum-on voltage Von and gate tum-off voltage Voff based on the control signals 232 and EQ, and supplies the pixel array 500 with a common electrode voltage Vcom.

The source driver 320 supplies the RGB selector 340 with the stored image data received from the first RGB interface 260. Alternatively, the source driver 320 may supply the RGB selector 340 with the stored MPEG-4 data received from the first RGB interface 260.

The level shifter 330 supplies the RGB selector 340 with second control signals including CLAO, CLBO and CLCO and supplies the gate driver 400 (see FIGS. 3, 4 and 11) with third control signals including SOUT1 through SOUT4 based on first control signals EQ, CLA, CLB, CLC and SIN1 through SIN4 provided from the timing generator 230.

The RGB selector 340 selects the stored image data (or the stored MPEG-4 data) received from the source driver 320, (based on the second control signals CLAO, CLBO and CLCO output from the level shifter 330), and provides the selected stored (image or MPEG-4) data to the pixel array 500.

The low voltage/high frequency circuit 200 may include an MPEG-4 CODEC 240 to perform a video decoder (CODEC) function. Alternatively, a circuit for 3-D implementation may also be included in the low voltage/high frequency circuit 200 to perform a 3-D decoder function.

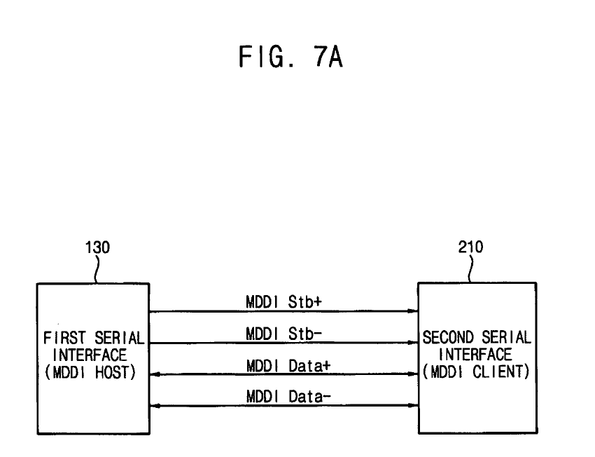

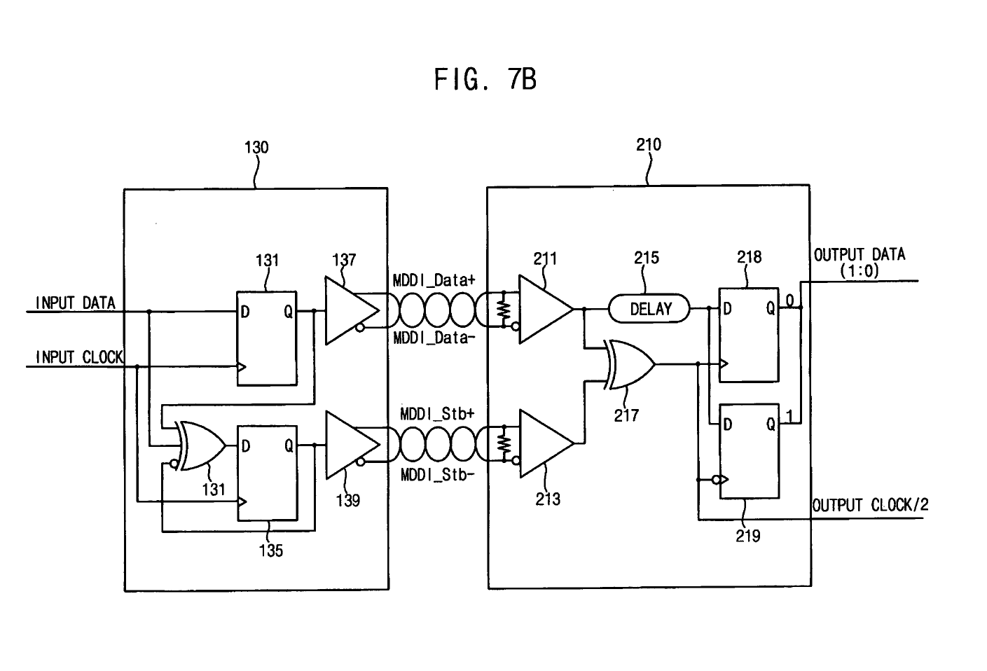

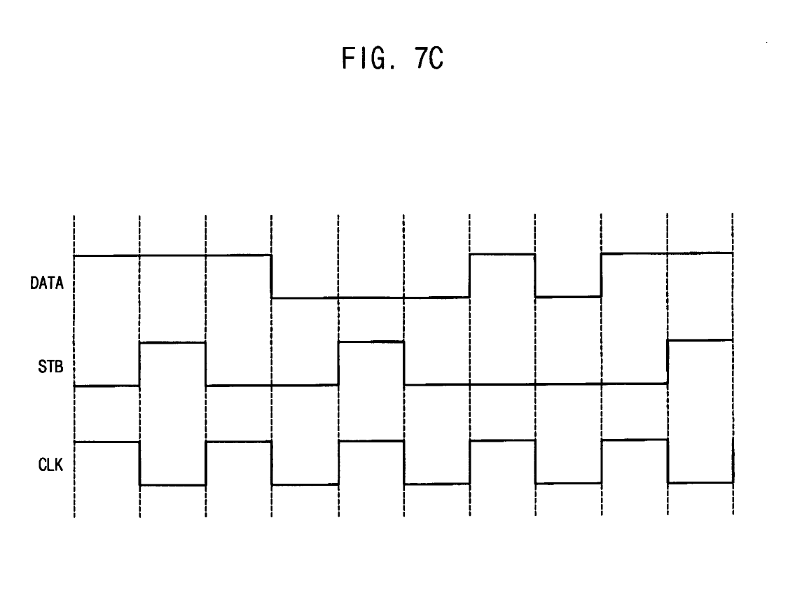

FIGS. 7A and 7B are circuit diagrams illustrating the interconnected first serial interface 130 and second serial interface 210 shown in FIG. 5A. More Particularly, FIG. 7A is a circuit block diagram illustrating operations of the first and second serial interfaces 130 and 210;, FIG. 7B is a detailed circuit diagram illustrating the internal logic of the first and second serial interfaces 130 and 210.

FIG. 7C is a signal waveform (timing) diagram illustrating signals of the first and second serial interfaces 130 and 210.

Referring to FIG. 7A, the first serial interface 130 is coupled to the second serial interface 210 via four interconnection lines: MDDI_Stb+; MDDI_Stb1−; MDDI_Data+; and MDDI_Data−. Two of the interconnection lines are used respectively to transmit an MDDI strobe signal MDDI_Stb+ having a positive polarity and an MDDI strobe signal MDDI_Stb− having a negative polarity. Two remaining interconnection lines are used respectively to transmit an MDDI data MDDI_Data+ having a positive polarity and an MDDI data MDDI_Data− having a negative polarity.

The MDDI strobe signals MDDI_Stb+ and MDDI_Stb− are transmitted from the first serial interface 130 to the second serial interface 210. The MDDI data MDDI_Data+ and MDDI_Data− are transmitted from the first serial interface 130 to the second serial interface 210, (or vice versa, from the second serial interface 210 to the second serial interface 210).

Referring to FIGS. 7B and 7C, the first serial interface 130 includes an exclusive OR-gate (XOR) 131, two D flip flops 133 and 135, and two differential drivers 137 and 139 to output the MDDI data (MDDI_Data+ and MDDL_Data−) and the MDDI strobe signals (MDDI_Stb+ and MDDI_Stb−) based on an input data INPUT DATA and an input clock INPUT CLOCK to the second serial interface 210.

The second serial interface 210 includes two differential receivers 211 and 213, a delay element DELAY 215, an exclusive OR-gate (XOR) gate 217 and two D flip flops 218 and 219 to restore the transmitted data as an output data OUTPUT DATA (1:0) and to output an output clock OUTPUT CLOCK/2 based on the MDDI data MDDI_Data+ and MDDI_Data−, and the MDDI strobe signals MDDI_Stb+ and MDDI_Stb− that are provided from the first serial interface 130.

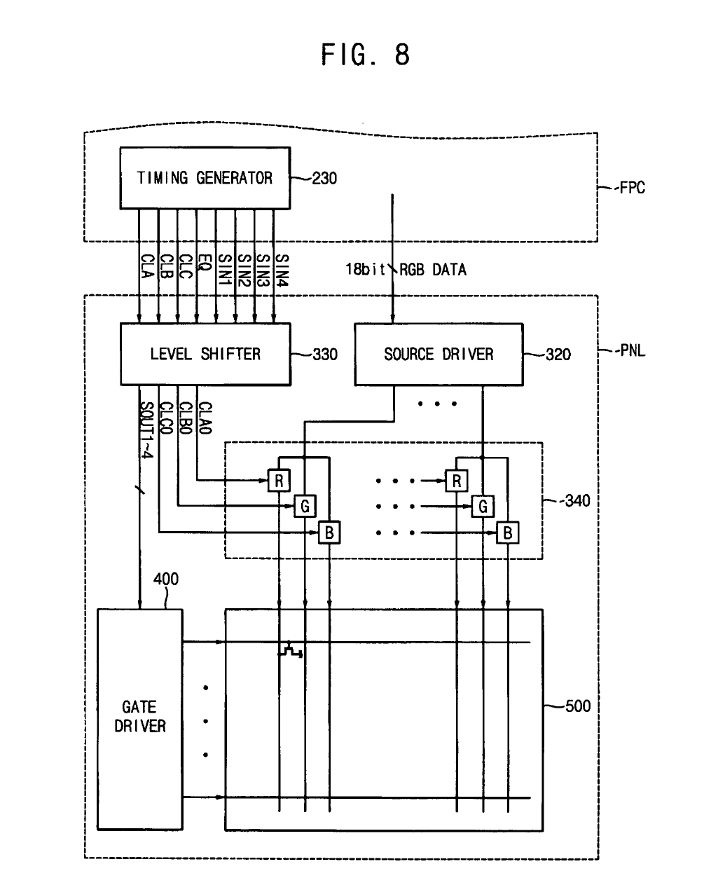

FIG. 8 is a detailed block diagram illustrating the pixel driving circuits of the liquid crystal display (LCD) device of FIGS. 5A and 5B integrated in the liquid crystal display panel PNL.

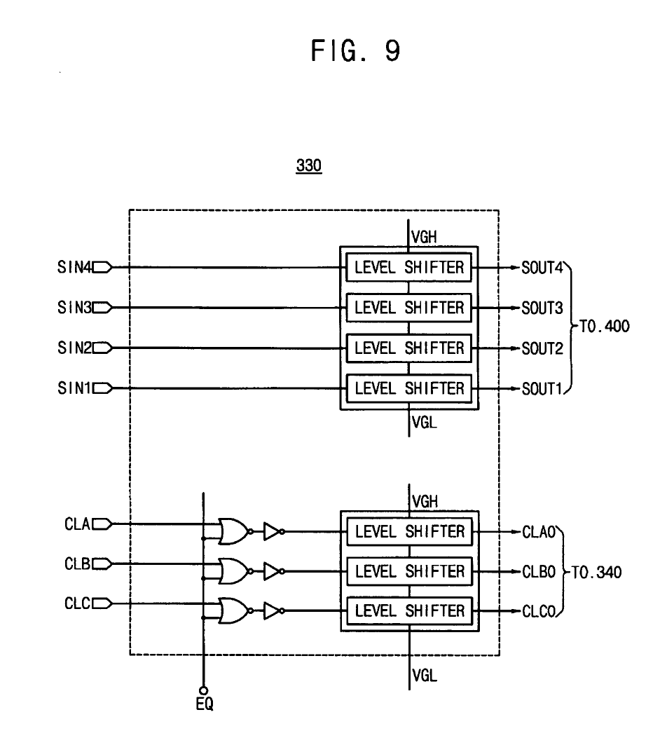

FIG. 9 is a detailed block diagram illustrating the level shifter 330 in FIGS. 5B and 8.

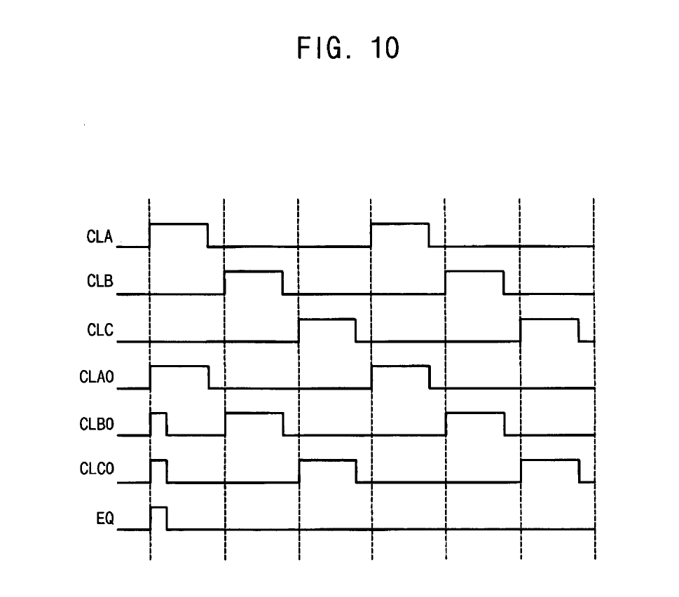

FIG. 10 is a timing diagram illustrating waveforms of input and output signals of the level shifter 330 in FIG. 9.

Referring again to FIGS. 5A and 5B and referring to FIGS. 8 through 10, the timing generator 230 (FIGS. 5A and 8) is mounted on the FPCB and the source driver 320, the level shifter 330 and the RGB selector 340 are mounted on the display panel PNL.

The timing generator 230 supplies the level shifter 330 of the high voltage/low frequency circuit 300 with a plurality of control signals EQ, CLA, CLB, CLC and SIN1 through SIN4.

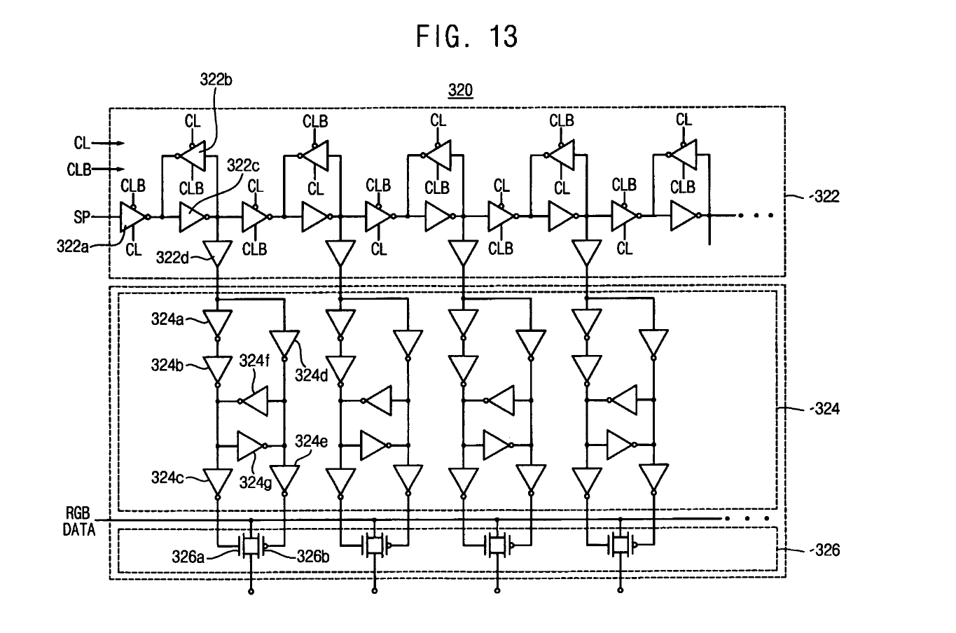

The source driver 320 (see FIGS. 8 and 13) converts the 18-bit image data supplied through the FPCB to an analog voltage to provide the analog voltage to the RGB selector 340. Thus, the source driver 320 comprises a Digital-to-Analog converter (DAC).

The level shifter 330 (see FIGS. 8 and 9) provides second control signals CLAO, CLBO and CLCO to the RGB selector 340 based on first control signals EQ, CLA, CLB, CLC and SIN1 through SIN4 and supplies third control signals SOUT1 through SOUT4 to the gate driver 400.

The RGB selector 340 supplies image signals having the analog data voltage(s) (supplied from the source driver 320) to a selected one of the source lines coupled to respective pixels for R (red), G (green) and B (blue) in the pixel array 500, based on the second control signals CLAO, CLBO and CLCO.

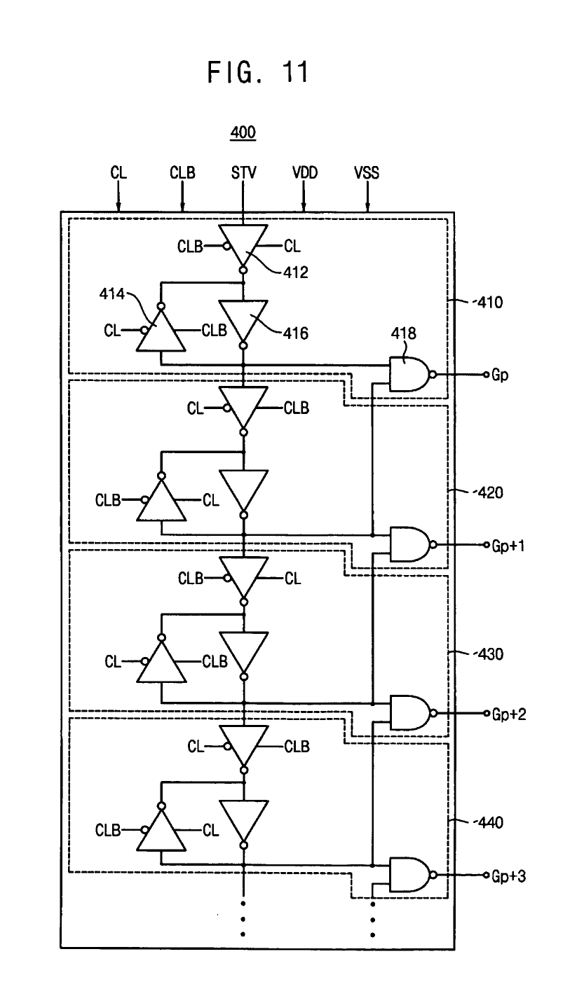

The gate driver 400 (see FIGS. 8 and 11) supplies gate lines coupled to the respective pixels with the gate tum-on voltage Von and the gate tum-off voltage Voff based on the third control signals SOUT1 through SOUT4 (supplied from the level shifter 330).

FIG. 11 is a circuit diagram illustrating the gate driver 400 shown in FIGS. 4 and 8.

Referring to FIG. 11, the gate driver 400 includes a shift register having a plurality of stages corresponding to respective gate lines in the pixel array 500 to output a plurality of gate signals Gp (G₁), Gp+1 (G₂), Gp+2 (G₃), . . . , based on the vertical synchronization start signal STV, first and second clocks CL and CLB and first and second power supply voltages VDD and VSS. Each of the stages includes two tri-state (gated) inverters 412 and 414, an inverter 416 and an NAND-gate 418. The NAND-gate 418 performs a NAND operation upon an output signal of the current stage (e.g.,410) of the shift register 400 and an output signal of a next stage (e.g., 420) of the shift register 400, to output the gate signals Gp (G₁), Gp+1 (G₂), Gp+2 (G₃), . . . of the shift register 400.

For example, the first stage 410 of the shift register outputs a first gate signal Gp (G₁) for activating a first gate line based on the vertical synchronization start signal STV, the first and second clocks CL and CLB, the first and second supply voltages VDD and VSS and an output signal of an inverter of the next (second) stage 420.

The second stage 420 outputs a second gate signal Gp+1 (G₂) for activating a second gate line based on an output signal of an inverter 416 of the first stage 410, the first and second clocks CL and CLB and the first and second supply voltages VDD and VSS.

Thus, the gate signals Gp (G₁), Gp+1 (G₂), Gp+2 (G₃), . . . , are sequentially outputted to the pixel array 500.

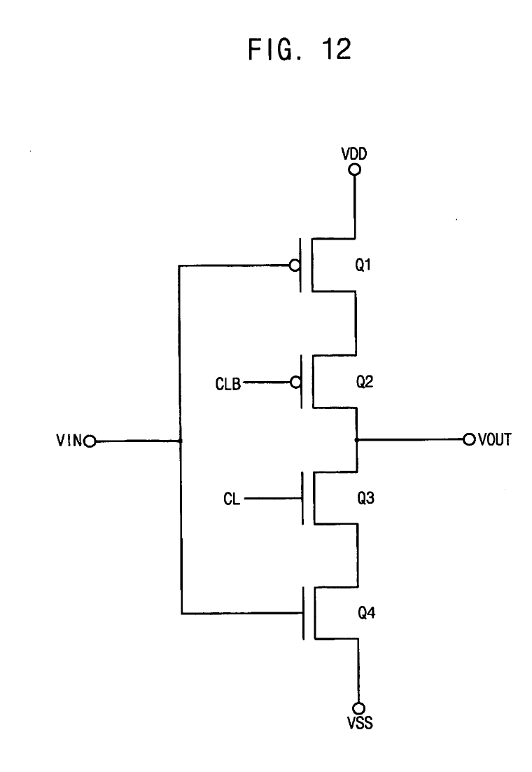

FIG. 12 is a detailed circuit diagram illustrating a poly-Si tri-state (gated) inverter as used in FIG. 11.

Referring to FIG. 12, the poly-Si tri-state (gated) inverter includes stacked (series connected) transistors comprising: first transistor Q1, a second transistor Q2, a third transistor Q3 and a fourth transistor Q4. The first and second transistors Q1 and Q2 may be P type switches (e.g., PFET transistors) and the third and fourth transistors Q3 and Q4 may be N type switches (e.g., NFET transistors).

The first transistor Q1 has a source terminal (to which the first supply voltage VDD is applied), a gate terminal (to which an input voltage VIN is applied) and a drain terminal (coupled to the source terminal of the second transistor Q2).

The second transistor Q2 has a source terminal (coupled to the drain terminal of the first transistor Q1), a gate terminal (to which the second clock CLB having a phase opposite to the first clock CL is applied) and a drain terminal (coupled to a source terminal of the third transistor Q3) and an output terminal configured output an output voltage VOUT (representing the inverse of the input voltage VIN).

The third transistor Q3 has a source terminal (coupled to the drain terminal of the second transistor Q2), a gate terminal (to which the first clock CL is applied) and a drain terminal (coupled to a source terminal of the fourth transistor Q4).

The fourth transistor Q4 has a source terminal (coupled to the drain terminal of the third transistor Q3), a gate terminal (to which the input voltage VIN is applied) and a drain terminal coupled to the second supply (e.g., ground, tum-off) voltage VSS.

The poly-Si tri-state (gated) inverter operates (e.g., outputs or suppresses the inverted input voltage VIN) based on the first and second clocks CL and CLB applied to the gate terminals of the second and third transistors Q2 and Q3.

FIG. 13 is a detailed circuit diagram illustrating the source (data) driver 320 shown in FIGS. 5B and 8.

Referring to FIG. 13, the source driver 320 includes a shift register 322, a holding unit 324 and a sampling unit 326.

The shift register 322 includes a plurality of stages to sequentially output a load control signal to the holding unit 324 based on a horizontal start signal SP, the first and second clocks CL and CLB and the first and second supply voltages VDD and VSS. Each of the stages includes two tri-stage (gated) inverters 322a and 322b, an inverter 322c and a buffer 322d.

The holding unit 324 includes a plurality of holding circuits. Each holding circuit includes a non-inverting buffer (e.g., comprised of serially coupled inverters 324a, 324b) coupled in series with a first output buffering inverter 324c, connected in parallel with an inverting buffer (e.g., inverter 324d) serially coupled to a second output buffering inverter 324e, and a storage latch comprising inverter 324f (coupled between an output terminal of the non-inverting buffer inverter 324b and an output terminal of the inverting buffer inverter 324d) and inverter 324g (coupled between an input terminal of the first output buffering inverter 324c and an input terminal of the second output buffering inverter 324e. The parallel inverters 324a and 324d are commonly coupled to an output of a stage of the shift register 322. The holding unit 324 holds (latches) an output signal of one state of the shift register 322.

The sampling unit 326 includes a plurality of sampling circuits. Each sampling circuit includes an N type switch (e.g., NFET transistor) 326a coupled to a first output terminal of the holding unit 324 and a P type switch (e.g., PFET transistor) 316b coupled to a second (complementary) output terminal of the holding unit 324, configured to sample an RGB data line based on an output signal of the holding unit 324.

Particularly, the N type switch (e.g., NFET transistor) 326a and the P type switch (e.g., PFET transistor) 326b have source terminals commonly coupled to receive and pass the RGB data. The RGB data is sampled based on an output signal provided from the first output terminal of the holding unit 324 to a gate terminal of the N type transistor 326a and a complementary output signal provided from the second output terminal of the holding unit 324 to a gate terminal of the P type transistor 326b.

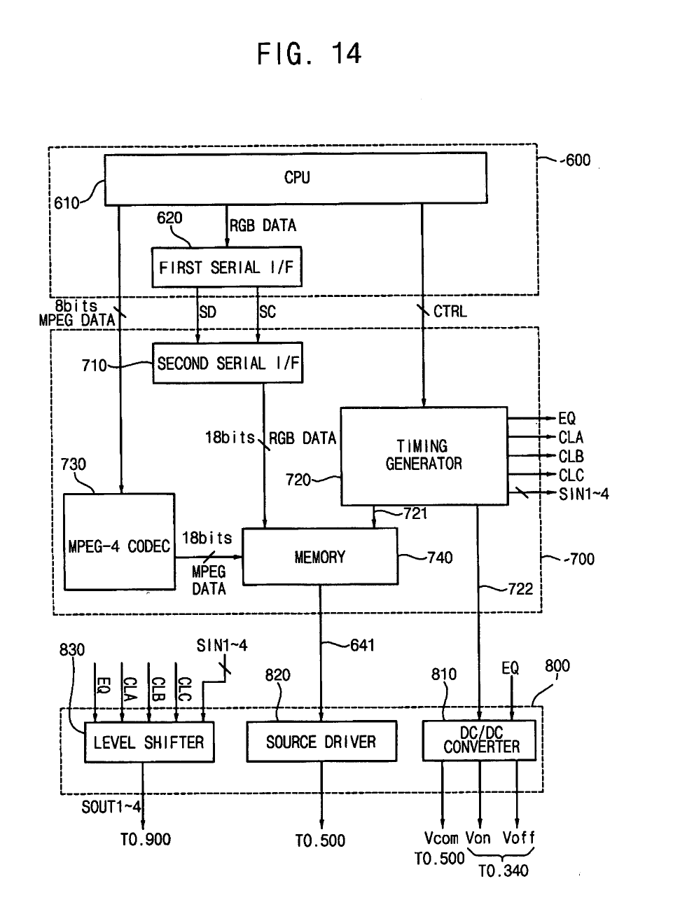

FIG. 14 is a circuit block diagram illustrating an apparatus for driving a liquid crystal display (LCD) device according to another exemplary embodiment of the present invention.

Referring to FIG. 14, the apparatus for driving the liquid crystal display (LCD) device includes a baseband IC 600, a low voltage/high frequency circuit 700 and a high voltage/low frequency circuit 800. The baseband IC 600 may be mounted (like baseband IC 100) on the PCB, the low voltage/high frequency circuit 700 may be mounted (like circuit 200) on the FPCB and the high voltage/low frequency circuit 800 may be mounted (like circuit 300) on the display panel PNL (see FIG. 3).

The baseband IC 600 includes a central processing unit (CPU) 610 and a first serial interface 620. The CPU 610 provides digital image data (RGB data) to the first serial interface 620 and provides the MPEG-4 data to the MPEG-4 decoder (730) in the low voltage/high frequency circuit 700.

The first serial interface 620 provides the serial data SD and the serial clock SC based on the digital image data (RGB data) to the low voltage/high frequency circuit 700. The serial data SD transmits MDDI data having a positive polarity and MDDI data having a negative polarity. The serial clock SC includes the MDDI strobe signal having a positive polarity and the MDDI strobe signal having a negative polarity.

For example, the MDDI data may include an image data corresponding to a red color, an image data corresponding to a blue color and an image data corresponding to a blue color, each of which has three bits.

The low voltage/high frequency circuit 700 includes a corresponding second serial interface 710, a timing generator 720, an MPEG-4 CODEC 730 and a frame buffer memory 740. The second serial interface 710 receives the serial data SD and the serial clock SC outputted from the first serial interface 620 and deserializes the serial data SD to supply the memory 740 with parallel 18-bit image data.

The timing generator 720 generates a plurality of control signals 721, 722, EQ, CLA, CLB, CLC and SIN1 through SIN4 based on a control signal CTRL outputted from the CPU 610 and provides the plurality of the control signals 721, 7222, EQ, CLA, CLB, CLC and SIN1 through SIN4 to the memory 740 and the high voltage/low frequency circuit 800.

The MPEG-4 CODEC 730 receives coded MPEG-4 data from the CPU 610 and decodes the MPEG-4 data to transmit the decoded MPEG-4 data to the memory 740. The coded MPEG-4 data may have eight bits and the decoded MPEG-4 data may have eighteen bits.

The memory 740 stores the 18-bit image data supplied through the second serial interface 710 and stores the 18-bit MPEG-4 data provided from the MPEG-4 CODEC 730 based on the control signal 721 provided from the timing generator 720.

The memory 740 supplies the high voltage/low frequency circuit 800 with the stored 18-bit image data or the stored 18-bit MPEG-4 data based on the control signal 721 provided from the timing generator 720.

The high voltage/low frequency circuit 800 includes a DC-to-DC converter 810, a source driver 820 and a level shifter 830. The DC-to-DC converter 810 provides a gate driver 900 with the gate turn-on voltage Von and the gate turn-off voltage Voff (based on the control signals 722 and EQ provided from the timing generator 720) and provides the pixel array 500 with the common electrode voltage Vcom.

The source driver 820 supplies the source line of the pixel array 500 with the image data or the MPEG-4 data provided from the memory 740.

The level shifter 830 supplies the gate driver 900 with second control signals including SOUT1 through SOUT4 based on first control signals EQ, CLA, CLB, CLC and SIN1 through SIN4 output from the timing generator 720.

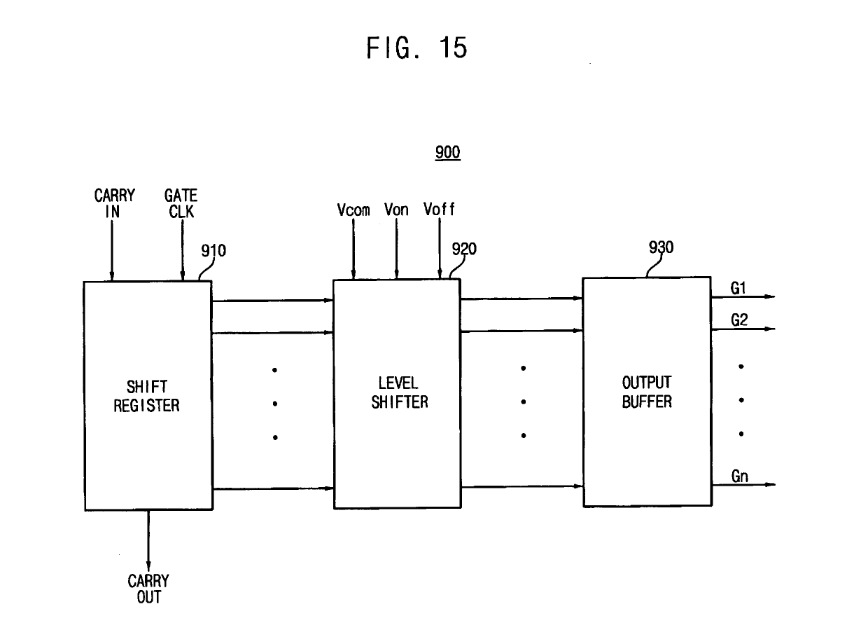

FIG. 15 is a block diagram illustrating a gate driver 900 for use with the circuit of FIG. 14.

Referring to FIG. 15, the gate driver 900 includes a shift register 910, a level shifter 920 and an output buffer 930. The shift register 910, the level shifter 920 and the output buffer 930 may include poly-Si thin film transistors (TFT).

The gate driver 900 sequentially outputs a plurality of gate signals G1, G2, . . . , Gn based on a carry signal CARRY, a gate clock signal GATE CLK, the common electrode voltage Vcom and the gate turn-on voltage Von and the gate turn-off voltage Voff.

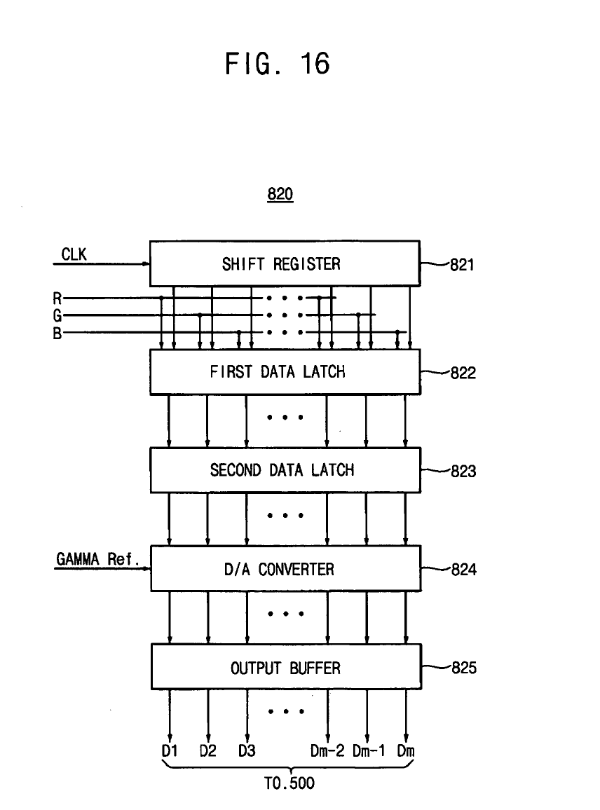

FIG. 16 is a detailed block diagram illustrating the source driver 820 in FIG. 14.

Referring to FIG. 16, the source driver 820 includes a shift register 821, a first data latch 822, a second data latch 823, a digital-to-analog converter (DAC, D/A) 824 and an output buffer 825. The shift register 821, the first data latch 822, the second data latch 823, the digital-to-analog converter (DAC) 824 and the output buffer 825 may include poly-Si thin film transistors (TFT).

The source driver 820 latches respective RGB data sequentially inputted, based on a dot clock to change a timing system from one dot at a time scanning method to one line at a time scanning method.

Data stored in the first data latch 822 is transferred to the second data latch 823 at every horizontal cycle and data stored in the second data latch 823 is converted to an analog voltage by the analog-to-digital converter 824. The analog voltage is applied to source lines D1, D2, . . . , Dm via the output buffer 825 and are applied to the pixel array 500.

As described above, in the poly-Si TFT LCD device, a dedicated IC in which a circuitry such as the memory, the high speed serial interface and the circuit for MPEG-4 or 3-D implementation, etc., operating at a relatively low voltage and a relatively high frequency is integrated may be provided to increase the manufacturing efficiency, while other circuitry such as the source driver, the gate driver and the DC-to-DC converter operating at a relatively high voltage and a relatively low frequency are integrated in the liquid crystal display panel.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A driver chip for a display device, the driver chip comprising:
a serial interface configured to convert a first image data received from a baseband IC to a second image data to output the second image data;
a timing generator configured to output a second control signal based on a first control signal provided from the baseband IC; and
a memory configured to store the second image data and configured to output the stored second image data to a display panel based on the second control signal.

2. The driver chip of claim 1, wherein the display panel includes a level shifter,
wherein an operating voltage of the level shifter is higher than an operating voltage of each of the serial interface, the timing generator and the memory, and an operating frequency of the level shifter is lower than an operating frequency of each of the serial interface, the timing generator and the memory.

3. The driver chip of claim 1, wherein the first image data includes three bits of image data corresponding to a red color, three bits of image data corresponding to a green color and three bits of image data corresponding to a blue color, and wherein the second image data has eighteen bits.

4. The driver chip of claim 1, wherein the first image data is a serial data and the second image data is a parallel data.

5. The driver chip of claim 1, further comprising an MPEG-4 decoder configured to decode an MPEG-4 data provided from the baseband IC to provide a decoded MPEG-4 data to the memory.

6. The driver chip of claim 5, wherein the MPEG-4 data has eight bits and the decoded MPEG-4 data has eighteen bits.

7. The driver chip of claim 5, wherein the display panel includes a level shifter,
wherein the MPEG-4 decoder has an operating voltage lower than the operating voltage of the level shifter and has an operating frequency higher than the operating frequency of the level shifter.

8. The driver chip of claim 1, wherein the serial interface includes a mobile display digital interface (MDDI) configured to receive a MDDI strobe signal having a positive polarity and a MDDI strobe signal having a negative polarity, MDDI data having a positive polarity, and MDDI data having a negative polarity,
wherein the serial interface decodes the MDDI data having the positive polarity and the MDDI data having the negative polarity to output a decoded MDDI data as the second image data.

9. The driver chip of claim 1, wherein the driver chip is mounted on a flexible printed circuit board (FPCB) that is electrically coupled between the printed circuit board (PCB) and the display panel.

10. A display device comprising:
a driver chip, including a first circuit operating at a relatively low voltage and at a relatively high frequency, and mounted on an FPCB that is electrically coupled to a display panel; and
the display panel including an array of pixels and a second circuit for driving the pixels, wherein the second circuit operates at a relatively high voltage and a relatively low frequency.

11. The display device of claim 10, wherein each of the pixels includes a switch.

12. The display device of claim 10, wherein the switch is a transistor having a channel layer of poly-silicon (poly-Si), connected to a gate line configured to transmit a gate signal.

13. The display device of claim 10, wherein the second circuit includes a level shifter,
wherein the operating voltage of the driver chip is lower than the operating voltage of the level shifter.

14. The display device of claim 13, wherein the operating frequency of the driver chip is higher than the operating frequency of the level shifter.

15. The display device of claim 10, further comprising a PCB, wherein the FPCB is electrically coupled to the PCB.

16. The display device of claim 15, further comprising a baseband IC.

17. The display device of claim 16, wherein the baseband IC includes:
a central processing unit (CPU) configured to output a first image data and a first control signal;
a graphic controller IC configured to output a second image data and a second control signal, based on the first image data and the first control signal;
a first serial interface configured to receive the second image data and to transmit the second image data; and
a first control interface configured to receive the second control signal and to transmit the second control signal.

18. The display device of claim 17, wherein the first circuit includes:
a second serial interface configured to convert the second image data received from the first serial interface to a third image data and configured to output the third image data;
a second control interface configured to convert the second control signal received from the first control interface to a third control signal and to output the third control signal;
a timing generator configured to output fourth, fifth and sixth control signals, based on the third control signal;
a memory configured to store the third image data and configured to output the stored third image data, based on the fourth control signal; and
a first RGB interface configured to convert the stored third image data provided from the memory to a fourth image data and to output the fourth image data.

19. The display device of claim 18, wherein the first circuit further includes an MPEG-4 decoder configured to decode an MPEG data provided from the CPU, and to provide the decoded MPEG data to the memory.

20. The display device of claim 10, wherein the second circuit includes:
a source driver configured to convert an image data provided from the first circuit to an analog voltage to output the analog voltage to the pixels;
a level shifter configured to output a level-shifted control signal based on a control signal received from the first circuit; and
a digital-to-digital converter configured to output a plurality of supply voltages.

21. The display device of claim 20, wherein the source driver includes:
a shift register configured to sequentially output a load control signal based on a horizontal start signal and first and second clocks provided from the first circuit; and
a sampling and holding unit configured to sample and hold the image data from the first circuit based on the load control signal.

22. The display device of claim 21, wherein the second circuit further includes a gate driver configured to sequentially output a gate signal based on the level-shifted control signal outputted from the level shifter.

23. The display device of claim 22, wherein the gate driver includes:
a shift register configured to sequentially output a load control signal based on a vertical start signal and first and second clocks provided from the first circuit; and
a NAND-gate configured to perform an NAND operation upon an output signal of a stage of the shift register and an output signal of a next stage of the shift register, to output the gate signal.

24. The display device of claim 22, wherein the second circuit further includes an RGB selector configured to determine an output path of the image data output from the source driver based, on the control signal provided from the level shifter.

25. The display device of claim 16, wherein the baseband IC includes:
a central processing unit (CPU) configured to output a first image data and a first control signal; and
a first serial interface configured to receive and transmit the first image data.

26. The display device of claim 25, wherein the first circuit includes:
a second serial interface configured to receive and to convert the first image data to a second image data;
a timing generator configured to output second, third and fourth control signals based on the second control signal; and
a memory configured to store the second image data and configured to output the stored second image data based, on the second control signal.

27. The display device of claim 25, wherein the CPU further outputs an MPEG data and a fifth control signal corresponding to the MPEG data,
wherein the first circuit further includes an MPEG-4 decoder configured to decode the MPEG data provided from the CPU to provide a decoded MPEG data to the memory, based on the fifth control signal.

28. The display device of claim 25, wherein the second circuit includes:
a source driver configured to convert the image data output from the first circuit to an analog voltage and to output the analog voltage to the pixels;
a level shifter configured to output a level-shifted control signal based on the third control signal output from the first circuit; and
a DC-to-DC converter configured to output a plurality of supply voltages, based on the fourth control signal output from the first circuit.

29. The display device of claim 28, wherein the source driver includes:
a shift register configured to sequentially output a load control signal based on a horizontal start signal and first and second clocks output from the first circuit;
a level shifter configured to level-shift the load control signal to output an level-shifted load control signal, based on one of supply voltages provided from the DC-to-DC converter; and
an output buffer configured to sequentially output the level-shifted load control signal.

30. The display device of claim 28, wherein the second circuit further includes a gate driver configured to sequentially output a gate signal, based on the level-shifted control signal outputted from the level shifter.
